(19) United States
(12) Patent Application Publication
(10) Pub. No.: US 2023/0067004 A1
(43) Pub. Date: Mar. 2, 2023

(54) METHODS AND SYSTEMS FOR REDUCING THE CONCENTRATION OF AMINE IN WASH LIQUID USED IN INDUSTRIAL PROCESSING

(71) Applicant: Research Triangle Institute, Research Triangle Park, NC (US)

(72) Inventors: Paul MOBLEY, Raleigh, NC (US); Shaojun James ZHOU, Cary, NC (US); Samuel John THOMPSON, Chapel Hill, NC (US); Jak TANTHANA, Durham, NC (US); Aravind Villava Rayer RABINDRAN, Morrisville, NC (US); Marty LAIL, Raleigh, NC (US)

(21) Appl. No.: 17/759,654

(22) PCT Filed: Jan. 26, 2021
(86) PCT No.: PCT/US21/15050

§ 371 Date: Jul. 28, 2022

Related U.S. Application Data
(60) Provisional application No. 62/967,338, filed on Jan. 29, 2020.

(51) Int. Cl. C02F 1/28; B01J 20/20; B01J 20/28; B01J 20/34; B01D 53/14

(52) U.S. Cl. CPC C02F 1/283; B01J 20/20; B01J 20/28016; B01J 20/3416; B01J 20/3466; B01J 20/3475; B01D 53/1475; B01D 53/1425; C02F 2103/18

(57) ABSTRACT

A method for reducing the concentration of amines in a wash liquid stream exiting a wash section in an acid gas scrubbing process includes introducing the wash liquid stream exiting the wash section of the acid gas scrubbing process to an adsorbent material, wherein the wash liquid stream has a first concentration of amines. The wash liquid stream having the first concentration of amines is flowed through the adsorbent material, and the adsorbent material retains at least a portion of the amines thereby providing a wash liquid stream having a second, reduced concentration of amines. The wash stream with reduced concentration of amines is recycled back to the wash section to remove amines more effectively from the acid gas being scrubbed. The adsorbent material can be regenerated for reuse. Amine recovered from the regenerated adsorbent material can be recycled to the process for reuse.

### CROSS-REFERENCE TO RELATED APPLICATION

This application claims priority to U.S. Provisional Patent Application No. 62/967,338, filed on Jan. 29, 2020, which is incorporated by reference herein in its entirety.

### STATEMENT REGARDING FEDERALLY SPONSORED RESEARCH OR DEVELOPMENT

This invention was made with government support under DE-FE0031660 awarded by US Department of Energy. The government has certain rights in the invention.

### BACKGROUND OF THE INVENTION

### Field of Invention

The invention relates to removal of amines from wash liquid used in industrial processes. For example, removal of amine from wastewater from an amine production facility or removal of amine from wash water used in a CO₂ capture process.

### Discussion of the Background

In industrial processes, it is desirable to recover and reuse materials in order to increase efficiency and reduce costs and environmental impact Amines are prevalent in industrial processes, for example, amine production and amine-solvent based processes for removing acid gases, such as CO₂, from process gas streams. As a result, amines are often found in industrial water streams. It is desirable to find a way to remove amines from wash liquid streams, for example, water streams in CO₂ scrubbing processes, in order to recycle and reuse the amine and the water.

Solvent-based processes for post-combustion CO₂ capture involve contacting a flue gas with a CO₂ scrubbing solvent typically in an absorber column. In the context of the present application, the scrubbing solvent is an amine-based scrubbing solvent. The solvent absorbs CO₂ from the flue gas, and the flue-gas stream leaves the absorber column with a reduced CO₂ content. The flue gas also picks up some amine from the solvent in the form of vapors and aerosols that exit the gas absorber column. To reduce the emissions from the carbon capture operations, and to reduce the amine lost to the atmosphere, it is desirable to recover entrained amine.

The treated flue gas, with the amine vapors, is generally scrubbed in a water wash column to reduce the amine emissions and amine loss. Alternatively, an organic solvent can be used to scrub amine vapors from the treated flue gas. After cleanup, the treated gas is sent to vent. It is desirable to remove the captured amine from the wash water and to return the recovered amine to the absorber for recycle of the solvent. It is also desirable to reuse the cleaned water in the wash water cycle. The cleaned wash water also has the ability to lower the amine emissions from the water wash, so that removing the amines from the wash water increases the amines removed from the treated flue gas. As one of ordinary skill in the art would understand, the lower the concentration of amines in the cleaned wash water, the more effective the cleaned wash water is in removing amines from the treated flue gas.

A schematic of a conventional post combustion CO₂ capture process with water wash is shown in FIG. 1. It will be understood that other acid gases, such as, for example, H₂S, SO₂, and HCl, can also be removed in acid gas scrubbing processes. U.S. Pat. No. 9,155,990 (the entire contents of which are incorporated herein by reference) describes a CO₂ capture process. In this process and with reference to FIG. 1, exhaust gas from combustion of carbonaceous fuel enters the CO₂ capturing plant through line 101.

The temperature of the exhaust entering the CO₂ capture plant is normally from about 25° C. to about 60° C. The exhaust gas (entering through line 101) is introduced into the lower part of a CO₂ absorber in which the exhaust gas flows from the bottom to the top of the absorber countercurrent to a lean liquid absorbent solvent, i.e., a solvent that absorbs CO₂, and that is introduced into the upper part of the absorber through lean absorbent line 108. CO₂ lean gas, i.e., absorber exhaust gas where a substantial part of the CO₂ is removed, is removed through the top of the absorber (stream 102) and enters a water wash section where vapors of the solvent are removed by the circulating water in the wash section. The low-CO₂ treated gas (stream 103) is then released to a vent. Rich solvent, i.e., solvent having absorbed the majority of the CO₂, is removed from the absorber through a rich absorbent line 104 at the bottom of the absorber.

The rich solvent is routed and is heated against lean solvent that is returned to the absorption tower in a heat exchanger, to a temperature typically in the range between 90 and 110° C., before the rich solvent (in line 105) is introduced into a regenerator column. In the regenerator column, the rich solvent flows downwards, countercurrent to steam generated by heating some of the solvent in a regeneration reboiler. Lean solvent leaves the regenerator at the base of the regenerator column in line 106. The lean solvent is introduced into a regeneration reboiler via line 106, where the lean solvent is heated to a temperature typically in the range between 110 and 130° C., to further remove CO₂ from the hot solvent and produce a vapor stream comprising CO₂ and water, which is entered into the regenerator in line 112.

The lean solvent is drawn from the reboiler (in line 107) and recycled back to the absorber (via line 108). CO₂ released from the solvent, water vapor and minor amounts of solvent, are withdrawn from the regenerator through a gas withdrawal line (line 109) at the top of the regenerator. The gas in the gas withdrawal line 109 is cooled in a condenser to condense water and minor amounts of solvent from the remaining gas, mainly comprising CO₂. CO₂ gas and some remaining water vapor is removed from the CO₂ separator for further treatment, such as drying, compression, and sequestration or for utilization in another process (via line 110). The condensed water and solvent in the CO₂ separator are withdrawn (via line 111) and pumped back to the top of the regenerator.

Typical solvents used for CO₂ removal are aqueous solutions of amines (such as monoethanolamine (MEA), diethanolamine (DEA), methyldiethanolamine (MDEA), 2-amino 1-propanol (AMP)) or blends of amines. These solvents are subject to emission regulation, which involves (as shown in FIG. 1) a water wash or an organic solvent wash. It is desirable to remove captured amine from the wash water or the organic solvent and to return the recovered amine to the absorber for recycle of the solvent. It is also desirable to reuse the cleaned water or cleaned organic solvent in the wash cycle to improve the wash effectiveness. A cleaned wash stream having relatively more captured amine removed is more effective at removing amines in the wash cycle.

### SUMMARY OF THE INVENTION

In a first aspect of the invention, a method for reducing the concentration of amines in a wash liquid stream exiting a wash section in an acid gas scrubbing process includes introducing the wash liquid stream exiting the wash section of the acid gas scrubbing process to an adsorbent material, wherein the wash liquid stream has a first concentration of amines, and flowing the wash liquid stream having the first concentration of amines through the adsorbent material, the adsorbent material retaining at least a portion of the amines thereby providing a wash liquid stream having a second, reduced concentration of amines. The wash liquid can be water, organic solvent or a combination thereof. The adsorbent material may be activated carbon, for example, coal-based activated carbon. The amine may comprise hydrophobic amines

In a second aspect of the invention, a method for reducing the concentration of amines in an acid gas scrubbing process gas effluent comprises introducing exhaust gas containing acid gas into an absorber vessel, the vessel containing a solvent comprising a solution having less than 50% water and one or more amines; flowing the exhaust gas through the solvent whereby at least a portion of the acid gas from the exhaust gas is absorbed by the solvent and at least a portion of the solvent is absorbed by the exhaust gas thereby forming a gas having an increased concentration of amine and a reduced concentration of acid gas; washing the gas with the increased concentration of amine with a wash liquid in a wash section thereby removing at least a portion of the amine from the gas and absorbing the removed amine into the wash liquid; introducing the wash stream exiting the wash section to an adsorbent material, wherein the wash stream has a first concentration of amines, flowing the wash stream having the first concentration of amines through the adsorbent material, the adsorbent material retaining at least a portion of the amines thereby providing a wash stream having a second, reduced concentration of amines, and recycling the wash stream having the second, reduced concentration of amines to the wash section in order to be reused therein, whereby providing a recycled wash stream with a relatively low concentration of amines to the wash section improves effectiveness of amine removal in the wash section thereby reducing the concentration of amines in the acid gas scrubbing process gas effluent. The wash liquid can be water, organic solvent or a combination thereof. The adsorbent material may be activated carbon, for example, coal-based activated carbon. The amine may comprise hydrophobic amines

In a third aspect of the invention, a method of regenerating an adsorbent material for reuse includes introducing steam to the adsorbent material, which has an initial concentration of amines adhered thereto, and treating the adsorbent material by flowing the steam there through whereby at least a portion of the adhered amine detaches from the adsorbent material such that the adsorbent material has a second, reduced concentration of amines adhered thereto after stream treatment thereby enabling reuse of the absorbent material.

In a fourth aspect of the invention, a method for recovering amine for reuse in a CO₂ scrubbing process includes introducing a gas containing CO₂ into an absorber vessel, the vessel containing a solvent comprising a solution having less than 50% water and one or more amines; flowing the gas through the solvent whereby at least a portion of the CO₂ from the gas is absorbed by the solvent and at least a portion of the solvent is absorbed by the gas thereby forming a gas having an increased concentration of amine; washing the gas with the increased concentration of amine with wash water thereby removing at least a portion of the amine from the gas and absorbing the removed amine into the wash water; introducing the wash water having the absorbed amine to an adsorbent material; flowing the wash water with the absorbed amine through the adsorbent material, the adsorbent material retaining at least a portion of the amine thereby providing wash water having a reduced concentration of amine; treating the adsorbent material by introducing and flowing steam through the adsorbent material having the retained amine adhered thereto thereby removing at least a portion of the retained amine; forming a stream of recovered amine comprising steam and/or condensed water and amine removed from the adsorbent material; and reintroducing the stream of recovered amine to the CO₂ scrubbing process.

It is to be understood that both the foregoing general description of the invention and the following detailed description are exemplary but are not restrictive of the invention.

### BRIEF DESCRIPTION OF THE FIGURES

A more complete appreciation of the invention and many of the attendant advantages thereof will be readily obtained as the same becomes better understood by reference to the following detailed description when considered in connection with the accompanying drawings, wherein:

FIG. 1 is a schematic of a conventional CO₂ capture system with a water wash.

FIG. 2 is a schematic showing an exemplary embodiment of a process flow diagram using the method described herein.

FIG. 3 is a schematic representation of a two-system approach that comprises an adsorption section and a desorption section.

FIG. 4 is a graph of amine concentration versus conductivity for 0-3 wt % with lean and rich amine

FIG. 5 is a graph showing the adsorption efficiency of the sorbent over time during the different cycles.

FIG. 6 is a graph comparing desorption rate versus time during different cycles.

FIG. 7 is a graph showing the estimated cumulative loading after each adsorption and desorption step and the working capacity during different cycles.

FIG. 8 is a graph showing adsorption efficiency in percent versus time in minutes.

FIG. 9 is a graph showing cumulative loading after each adsorption and desorption step and the working capacity during the different cycle.

FIG. 10 is a chart showing the efficiency in percent for each sorbent for selected cycles.

FIG. 11 is a chart comparing relative working capacity for Sorbent 1 and Sorbent 2.

FIG. 12 is a plot of amine out versus amine in and wash temperature produced by a model.

FIG. 13 is plot of percent capture versus amine in and wash temperature.

FIG. 14 is a line chart showing the amine emission concentration of the outlet stream for the second water wash over time.

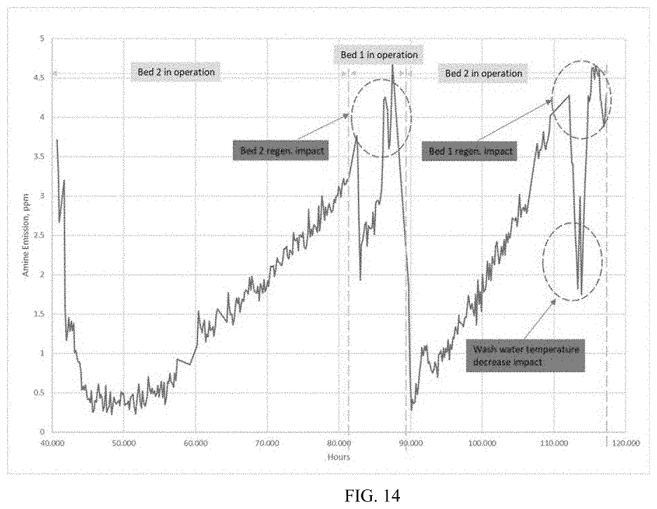

FIG. 15 is a line chart showing the amine emission concentration in the sump water stream and top water stream of the second water wash over time.

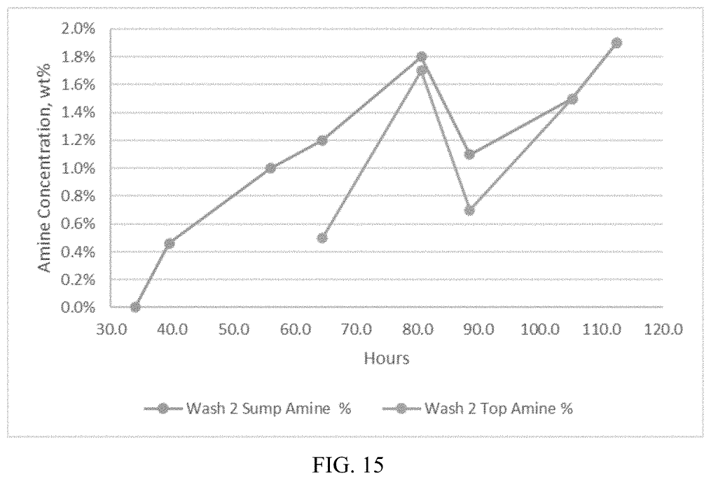

### DETAILED DESCRIPTION OF THE INVENTION

Described herein is a method for reducing the concentration of amines in a wash liquid. The exemplary embodiments described herein relate to reducing the concentration of amines in wash water. However, one of skill in the art will understand that a wash liquid may include organic solvents. Amines are present in water streams in many industrial processes. For example, amine can be found in wastewater discharged from an amine production facility. Additionally, as described above, amine can be found in wash water used in an acid gas scrubbing process, such as a CO₂ scrubbing process. The method described herein for reducing the concentration of amine in water can be used effectively in many different applications. Removing amine from water will be described in the present application in the context of wash water in a CO₂ scrubbing process. However, one of ordinary skill in the art will understand that the amine removal process can be applicable in other industrial contexts.

In a CO₂ scrubbing process, CO₂ present in exhaust gas from combustion of carbonaceous fuel is absorbed by liquid absorbent solvent (e.g., aqueous solutions of amines) in an absorber column. CO₂ lean gas (i.e., absorber column exhaust gas from which a substantial part of the CO₂ has been removed) exits the top of the absorber column and enters a wash section where amines derived from the amine solvent are removed by the circulating liquid wash in the wash section. The liquid wash can be water, organic solvent, or a combination thereof. Exemplary organic solvents used as wash liquids include tri-ethyleneglycoldibutylether and Genosorb® 1843. The hydrophobicity of solvents such as tri-ethyleneglycoldibutylether and Genosorb® 1843 is like that of many hydrophobic amines and therefore have a high solubility for those amines and act well as wash liquids, while also exhibiting a low vapor pressure to not further contribute to emissions from the process. Other exemplary organic solvents include but are not limited to propanol, butanol, dichloromethane, di-ethyleneglycoldibutylether, tetraethyleneglycoldibutylether or combinations thereof. The method for reducing the concentration of amines in a wash stream exiting the wash section includes introducing the wash stream exiting the wash section of the CO₂ scrubbing process to an adsorbent material, wherein the wash stream has a first, relatively high concentration of amines. The wash stream having the first concentration of amines is flowed through the adsorbent material such that the adsorbent material retains at least a portion of the amines After flowing through the adsorbent material, the wash stream has a second, reduced concentration of amines. Adsorption is the adhesion of atoms, ions or molecules from a gas, liquid or dissolved solid to a surface. Adsorption differs from absorption, wherein a liquid or gas (the absorbate) is dissolved by or permeates a liquid or solid (the absorbent), respectively.

Adsorbents can be in multiple physical forms, including, for example, powder, granular, and extruded. Each form is available in many sizes. The form and size used is generally application dependent. Adsorbents generally have high abrasion resistance, high thermal stability, and small pore diameters, which provides higher exposed surface area and hence high capacity for adsorption. In embodiments, the adsorbent material may have an average adsorption efficiency, which is at least 30% for a run time of 1 hour to 15 hours. In other embodiments, the adsorbent material may have an average adsorption efficiency of at least 50% for a run time of 1 hour to 10 hours.

In embodiments of the process described herein, the adsorbent material used for removing amines from wash stream is activated carbon. Activated carbon is a carbonaceous, highly porous adsorptive medium that has a complex structure composed primarily of carbon atoms. Activated carbon generally has a highly porous structure of nooks, crannies, cracks and crevices between carbon layers. Activated carbons can be manufactured from coconut shell, peat, hard and soft wood, lignite coal, bituminous coal, olive pits and various carbonaceous specialty materials.

The intrinsic pore network in the structure of activated carbons enables them to be effective adsorbents. In some instances, adsorption can occur in pores slightly larger than the molecules that are being adsorbed, which is why it can be important to match the molecule being adsorbed with the pore size of the activated carbon. Without being bound by theory, it is believed that the molecules are trapped within the carbon's internal pore structure by Van Der Waals Forces or other bonds of attraction and accumulate onto the solid surface.

In general, for activated carbon, the higher the internal surface area, the higher the effectiveness of the carbon. The surface area of activated carbon is high. It can be 500 to 1500 m²/g or higher. The total pore volume of the activated carbon refers to all pore spaces inside a particle of activated carbon. In general, the higher the pore volume, the higher the effectiveness. However, if the sizes of the molecules to be adsorbed are not a good match to the pore size, some of the pore volume will not be utilized.

In an embodiment of the described process, the activated carbon is coal-based activated carbon. Coal-based activated carbon can be beneficial for use in adsorbing relatively higher concentrations of amine, for example, relatively higher concentrations of hydrophobic amines Coal-based activated carbon can be used to adsorb percent-level quantities of amine, for example, percent level quantities of hydrophobic amine.

In another embodiment, the adsorbent is a coal-based activated carbon in the form of a fixed adsorbent bed through which the water having the first concentration of amine is introduced as a stream that flows through the fixed adsorbent bed. The process may include multiple fixed adsorbent beds that can be switched with one another when one bed nears or reaches adsorption capacity.

The amine being removed from the water can be any amine suitable for use in the applicable industrial process. An exemplary amine can include a primary amine, a secondary amine, a diamine, a triamine, a tetraamine, a pentamine, a cyclic amine, a cyclic diamine, an amine oligomer, a polyamine, an alkanolamine, or mixtures thereof. In an embodiment, the amine has a pKa of about 8 to about 15. In another embodiment, the amine is selected from the group consisting of primary amines, secondary amines, diamines, triamines, tetraamines, pentamines, cyclic amines, cyclic diamines, amine oligomers, polyamines, alcoholamines, guanidines, amidines, and mixtures thereof. Potential suitable amines include, but are not limited to, 1,4-diazabicyclo-undec-7-ene (“DBU”); 1,4-diazabicyclo-2,2,2-octane; piperazine (“PZ”); triethylamine (“TEA”); 1,1,3,3-tetramethylguanidine (“TMG”); 1,8-diazabicycloundec-7-ene; monoethanolamine (“MEA”); diethylamine (“DEA”); ethylenediamine (“EDA”); 1,3-diamino propane; 1,4-diaminobutane; hexamethylenediamine; 1,7-diaminoheptane; diethanolamine; diisopropylamine (“DIPA”); 4-aminopyridine; pentylamine; hexylamine; heptylamine; octylamine; nonylamine; decylamine; tert-octylamine; dioctylamine; dihexylamine; 2-ethyl-1-hexylamine; 2-fluorophenethylamine; 3-fluorophenethylamine; 3,5-difluorobenzylamine; 3-fluoro-N-methylbenzylamine; 4-fluoro-N-methylbenzylamine; N-methylbenzylamine; imidazole; benzimidazole; N-methyl imidazole; 1-trifluoroacetylimidazole; 1,2,3-triazole; 1,2,4-triazole; and mixtures thereof. In an embodiment, the amine may comprise N-methylbenzylamine, di-ethyleneglycoldibutylether, tri-ethyleneglycoldibutylether, tetraethyleneglycoldibutylether or a combination thereof. Additionally, the amine may consist of N-methylbenzylamine and a mixture of di-ethyleneglycoldibutylether, tri-ethyleneglycoldibutylether, and tetraethyleneglycoldibutylether.

In an embodiment, potential amines include hydrophobic amines Hydrophobic amines are often used in water lean solvents, i.e., solvents having less than 50% water. Because of the reduced water content, the concentration of amine in the water lean solvent is relatively high. Alternatively, many CO₂ capture processes use hydrophilic amines in aqueous based solvents. The amount of water in the aqueous based solvent is relatively higher than that in water lean solvents. As a result, the concentration of hydrophilic amine in a water-based solvent is relatively lower than the concentration of hydrophobic amine in water lean solvents. Thus, depending on the vapor pressure of the amine in each solvent, the amount of hydrophobic amine to be removed from the wash liquid may be relatively higher than in corresponding systems that use aqueous-based solvents having hydrophilic amines. In addition, the hydrophobicity of hydrophobic amines reduces the affinity for the amine to be absorbed in the wash liquid and lowers the driving force for absorption relative to hydrophilic amines. As a result, the effectiveness of wash sections is generally lessened for hydrophobic amines compared to hydrophilic amines, and the method detailed here can be used to improve the wash effectiveness of a hydrophobic-amine-laden gas.

The method described herein also includes a method for regenerating the adsorbent material for reuse after the amine has been adsorbed thereto. As one of ordinary skill in the art will understand, it is desirable to reuse materials in industrial processes to increase efficiency and reduce costs and environmental impact. The adsorbent can be regenerated by removing or detaching the amine adsorbed thereto. In embodiments, the amine can be detached using steam or organic solvents. An exemplary organic solvent used for detaching amine from an adsorbent material includes treating activated carbon with methanol. The resulting solution of methanol and amine can be distilled to produce a purified amine for reuse. Other exemplary organic solvents include but are not limited to ethanol, isopropanol, acetone, ethyl acetate, and tetrahydrofuran.

In an exemplary embodiment, steam is introduced to the adsorbent material that has the amine adsorbed thereto, and the adsorbent material is treated by flowing the steam there through. Contacting the amine-laden adsorbent with steam causes at least a portion of the adhered amine to detach from the adsorbent material thus reducing the concentration of amine on the adsorbent material thereby enabling reuse thereof. Different flowrates of steam may be used. For example, a flowrate that produces a superficial steam velocity of 2-20 m/min may be used. Different temperatures of steam may be used. For example, steam at a temperature of between about 100-180° C. may be used. The steam may be at a pressure of 1-10 bar. The adsorbent may be treated with steam for varying amount of time depending on the kind of amine being removed, the total volume of amine being removed, the kind of adsorbent being regenerated, the volume of adsorbent being regenerated, the processing conditions being used for regeneration, etc. For example, regenerating treatment with steam may take place for a time of 5 minutes to 60 minutes. For example, steam regeneration may be performed for 5, 10, 15, 20, 25, 30, 35, 40, 45, 50, 55, or 60 minutes. In embodiments, multiple vessels containing adsorbent beds may be used interchangeably, such that one bed can be regenerated while another bed is being used for adsorbing amine. When one bed reaches its adsorbing saturation limit or capacity or for process optimization, it can be switched or interchanged with a bed that has been regenerated.

The method described herein also includes reusing the amine recovered from the regenerated adsorbent material in the CO₂ scrubbing process. The amine that is detached from the adsorbent with steam treatment can be combined with the steam or condensed water formed from the steam and returned to the process in a suitable location in the form of a recovery stream. The recovered amine may be relatively dilute in the condensed water stream. For example, the amine may be 1-10 wt % in the stream. The stream with recovered amine may be reintroduced to the system in a first water wash or with the solvent in the absorber column. Alternatively, the amine may be separated or concentrated for further use, depending on the application.

The described process can increase the efficiency of a wash section for removal of amines, especially hydrophobic amines, derived from process gas streams, including CO₂ capture units from electricity generating units. The wash liquid, for example, wash water, can be circulated through switchable fixed beds of activated carbon that adsorb amines from the wash water. Before the activated carbon bed becomes saturated with amines, the flow can be switched to another carbon bed and the first bed can be regenerated with steam. The process can interchange beds, alternating between adsorption and regeneration.

By removing amines from the wash liquid more effectively, the concentration of amine in the wash liquid is reduced thereby increasing the driving force for the amine to absorb in the cleaned wash liquid. Accordingly, wash efficiency is increased and amine emissions from wash liquid are reduced. Modeling has shown that this process can reduce amine weight fraction in cleaned wash water by two orders of magnitude, which reduces the equilibrium partial pressure of amines in the treated gas similarly.

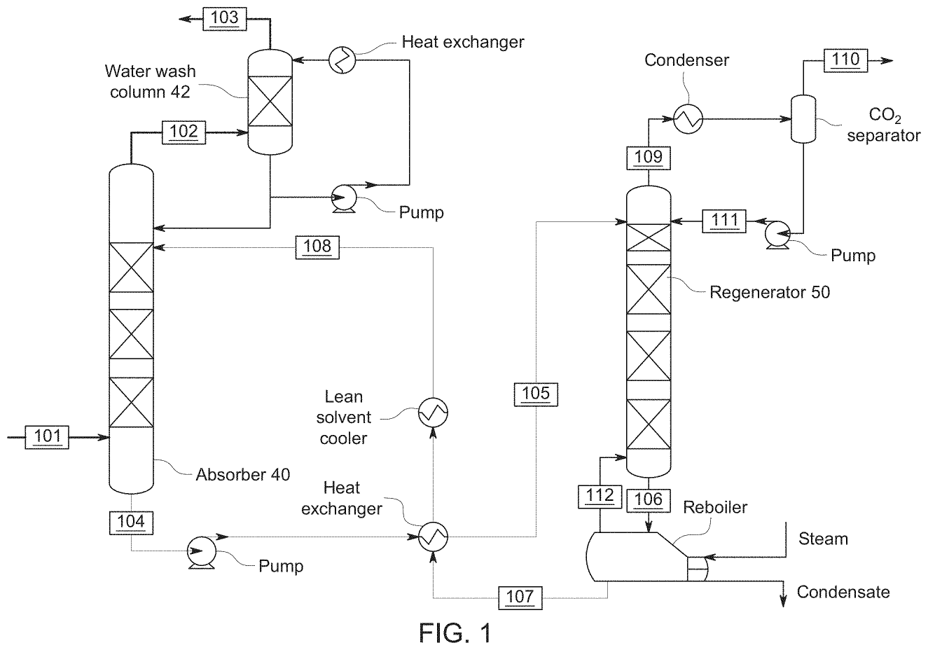

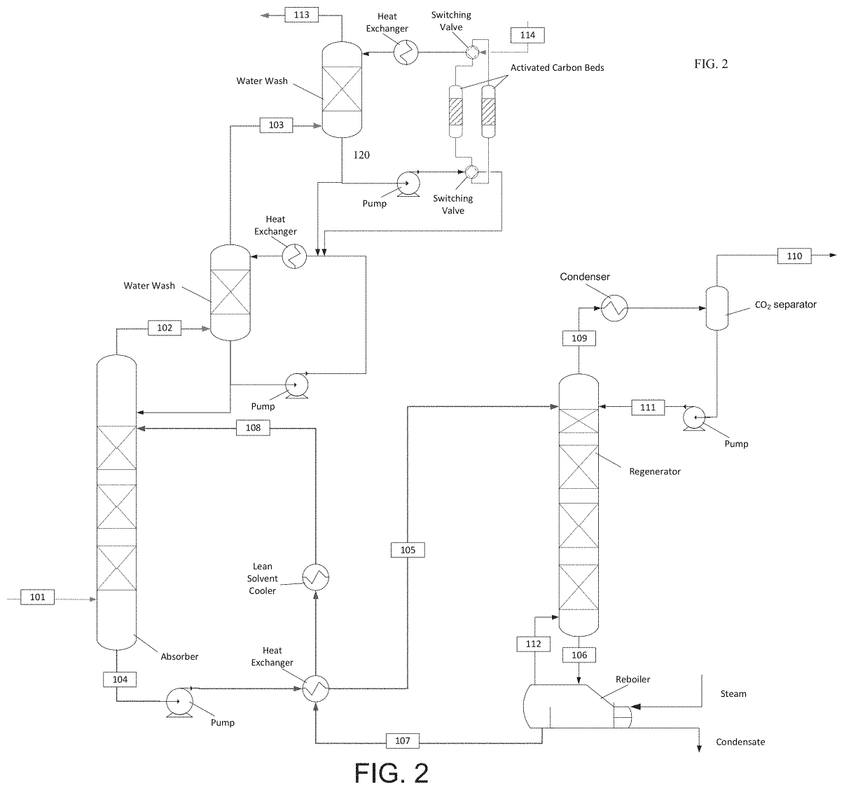

FIG. 2 is a schematic showing an exemplary embodiment of a process flow diagram using the method described herein. The numbering in FIG. 2 is the same as that in FIG. 1 for processing units that are common to both figures. FIG. 2 includes two water wash units, a first water wash and a second water wash. Stream 103 is introduced to the first water wash and stream 103 is introduced to the second water wash. Water wash effluent stream 120 leaves the second water wash and is introduced to the activated carbon beds for removal amine. As can be seen in FIG. 2, stream 120 can be routed through one adsorber bed while the other bed is being regenerated with steam provided via line 114. The bed being used for adsorption can be switched with the bed being regenerated by using the switching valve. Cleaned water leaving the adsorber bed can be recycled to the second water wash and reclaimed amine leaving the regenerated adsorber bed can be recycled to the first water wash. Although not shown, recovered amine can be further separated and concentrated using known methods, for example, distillation. Moreover, recovered amine can be returned to the absorber column directly rather than to the first water wash.

### EXAMPLES

### Example 1

Testing was performed to evaluate adsorption and regeneration performance.

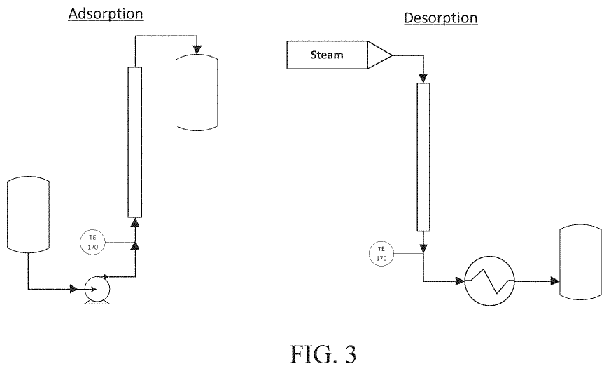

A two-system approach with a detachable fixed sorbent bed was used to analyze the amine capture properties of a sorbent. FIG. 3 provides a schematic representation of the two-system approach that comprises an adsorption section and a desorption section. The adsorption system consisted of a vessel containing a solution of amine and water, a fixed sorbent bed, and a collection vessel. The sorbent in the bed was coal-based activated carbon. The regeneration system contained a steam source, the same fixed sorbent bed, a condenser coil, and a collection vessel. With the regeneration process, a temperature probe after the fixed sorbent bed was used to determine when steam broke through the bed.

In the experiment, a cycle started with pumping an amine solution through approximately 6 grams of sorbent. After adsorption for a set time, the bed was detached and transferred to a steam production unit where 2 mL/min of steam stripped the amine off the sorbent. The bed went through eight cycles of testing. Table 1 outlines the operating conditions for the cycles.

TABLE 1
Operating conditions

| | Adsorption | Regeneration |
|---|---|---|
| Test Length | 65 min | 65 min |
| Sampling | 4 min sample, every | 4-6 min sample, 2 min |
| | 10 min | between sample |
| Flow Rate | ~4 g/min 1 wt % amine sol. | 1-2 g/min steam |

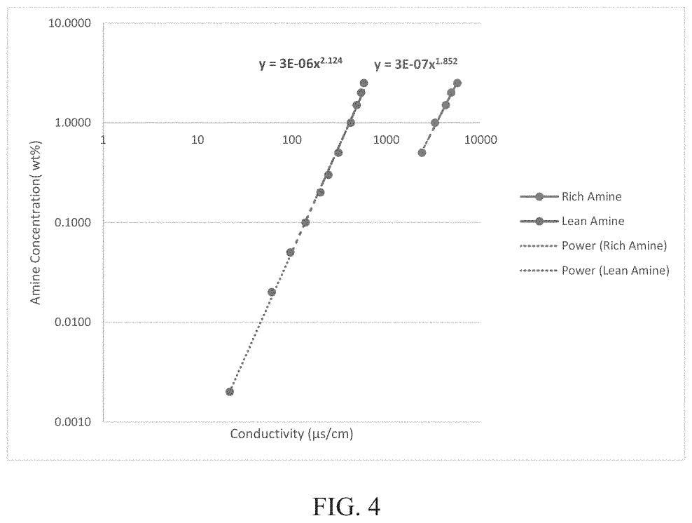

During the first 3 cycles, collected samples were analyzed with an auto-titrator to determine the amine wt % of each sample. After the third cycle, a calibration curve that correlated conductivity to amine wt % was determined to be an accurate and efficient means to determine amine wt %. FIG. 4 provides a graph of amine concentration versus conductivity for 0-3 wt % with lean and rich amine. This calibration was created by measuring the conductivity of known, prepared amine wt % standards between 0-3 wt %. The relationship was found to fit a power law very well and is shown plotted on a log-log plot. Due to the potential two-phase nature of the non-aqueous solvent amine and water at concentrations higher than 1 wt %, a calibration that compared amine wt % and conductivity after bubbled with CO₂ to form one phase was also created. Samples that showed a cloudy, two-phase system were bubbled with CO₂ for approximately one minute until a one-phase solution was achieved.

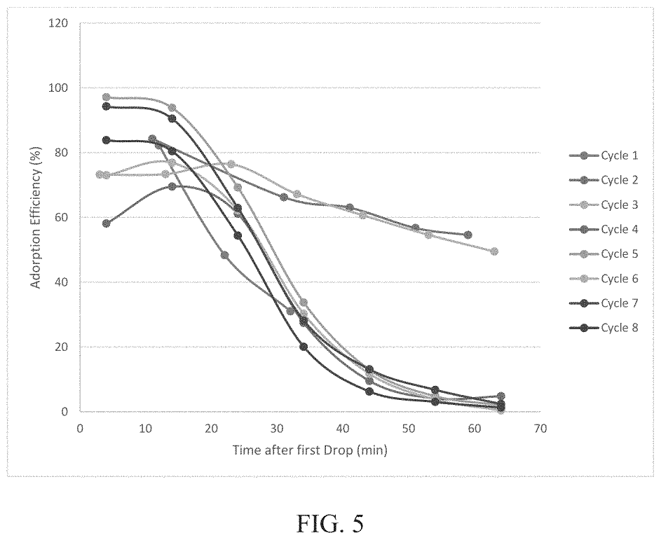

FIG. 5 shows the adsorption efficiency of the sorbent over time during the different cycles. Full breakthrough of the bed did not occur until the fourth cycle. However, the breakthrough profile was repeatable during the subsequent tests.

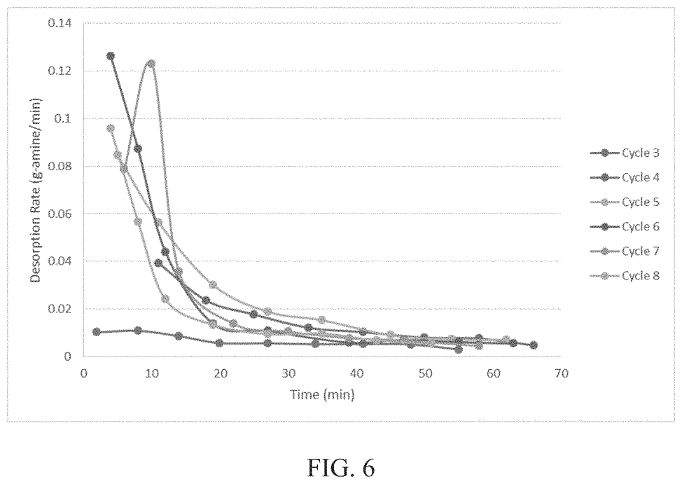

The sorbent was regenerated during each cycle using steam and desorption was found to be fast and most desorption occurred in the first twenty minutes of steam exposure. FIG. 6 is a graph comparing desorption rate versus time during different cycles. FIG. 6 shows desorption rate over time for most of the cycles. The temperature probe showed that the steam broke through the bed in 10 minutes on average, which was just a couple of minutes after the first drops of condensate left the bed. There was a minimal amount of desorption in the first three cycles until the sorbent broke through on the bed. This indicated that almost all the first amines captured on the sorbent were tightly bound to the sorbent, however, after a full loading of amine on the sorbent, a portion of the amine could be desorbed from the sorbent.

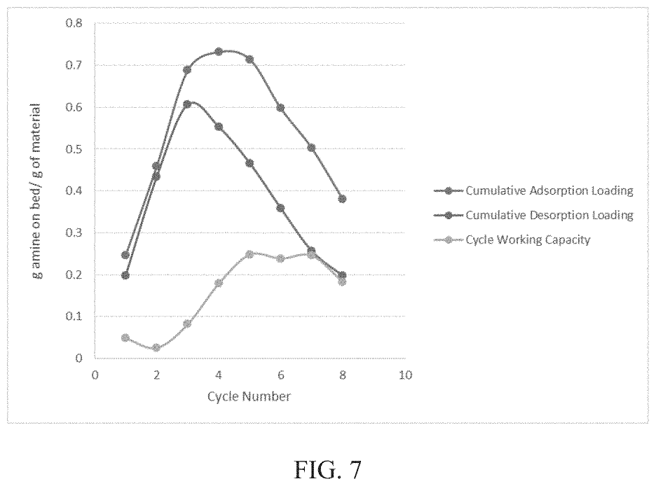

The cumulative loading of the amine on the sorbent was estimated from the samples after each adsorption and desorption cycle. FIG. 7 is a graph showing the estimated cumulative loading after each adsorption and desorption step and the working capacity during different cycles. FIG. 7 shows the lack of desorption during the first three cycles while the sorbent is reaching full capacity. From cycle four through eight, a more stable working capacity of approximately 0.2 to 0.25 g-amine/g-sorbent was measured. The decreasing trends in the cumulative loading indicate that an underestimation of the adsorption was likely as the cumulative desorption loading was expected to be approximately constant because of the measured performance during the first three cycles.

### Example 2

Testing was performed to evaluate adsorbent performance for two exemplary adsorbents.

In the testing, Sorbent 1 was coal-based activated carbon and Sorbent 2 was coconut-shell activated carbon. The testing showed that Sorbent 1 was more efficient than Sorbent 2.

The same adsorption setup used for Example 1 was used for Sorbent 1 in Example 2. Four sets of test conditions were conducted on the bed of 6 grams of Sorbent 1. These sets were conducted to analyze the impact that concentration and flow rate have on the amine capture performance Table 2 outlines the operating conditions for the four sets.

TABLE 2
Operating Conditions

| | Amine Conc. | Flow Rate |
|---|---|---|
| Cycle # | (wt %) | (g/min) |
| 1-8 | 1 | ~3.5 |
| 9 | 1 | 4 |
| 10-11 | .02 | 50 |
| 12 | 1 | 3.75 |

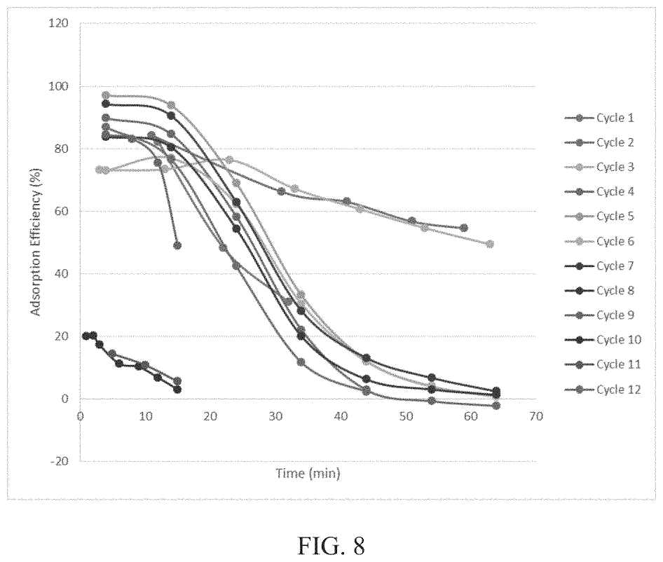

FIG. 8 is a graph showing adsorption efficiency in percent versus time in minutes. FIG. 8 shows the adsorption efficiency of the sorbent over time during the different cycles. The breakthrough on the sorbent bed followed a repeatable pattern after the bed was fully loaded in Cycle 4, except for the higher flowrate and exceptionally low concentration of Cycles 10 and 11 which reduced the overall efficiency.

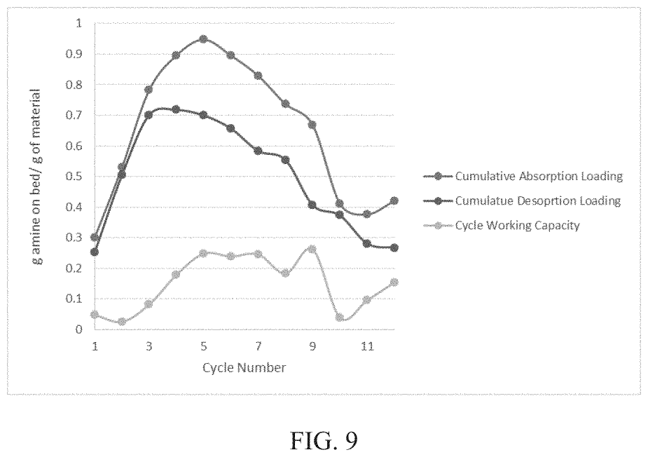

The cumulative loading of the amine on the sorbent was estimated from the samples collected at the outlet during each adsorption and desorption cycle. FIG. 9 is a graph showing cumulative loading after each adsorption and desorption step and the working capacity during the different cycle. FIG. 9 shows the estimated loading and the resulting working capacity from Example 1 with the additional 5 runs of Example 2. The higher flows of Cycles 10 and 11 caused lower working capacity to be achieved but a normal operating condition with Cycle 12 shows it returning to a more stable working capacity of 0.15-0.2 g-amine/g-sorbent. The decreasing trends in the cumulative loading indicate that a small underestimation of the adsorption and overestimation of desorption was likely as both factors depend on samples that were not instantaneous but rather through a sample accumulation of 5-10 mins and did not account for the liquid retained in the test system at the end of the experiments.

A new bed of 5.3 grams of Sorbent 2 was set up to compare its amine capture performance with that of Sorbent 1. For 3 of the 5 total cycles, the amine concentration was maintained at 1% with a flow rate of 4 g/min to best compare Sorbent 2 to Sorbent 1.

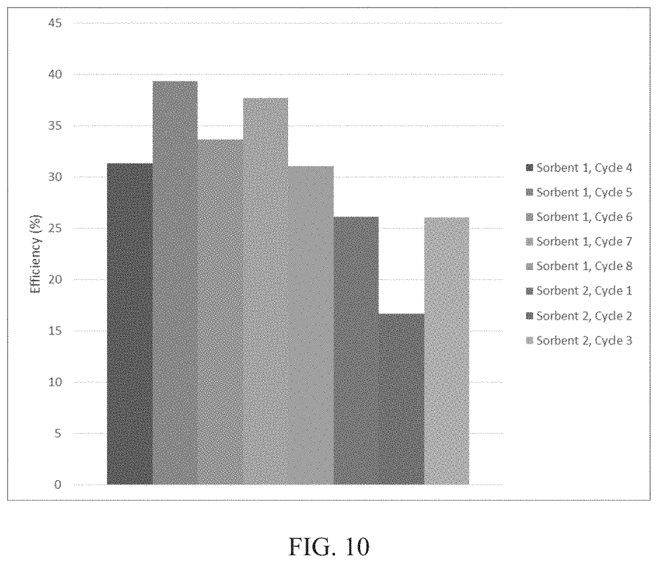

FIG. 10 is a chart showing the efficiency in percent for each sorbent for selected cycles. FIG. 10 compares the overall adsorption efficiency for each cycle between Sorbent 1 and Sorbent 2. The cycles shown in FIG. 10 were tested at ˜4 g/min with an amine concentration of 1%. As FIG. 10 shows, on average, Sorbent 1 had an efficiency of 5-10 percentage points better than Sorbent 2.

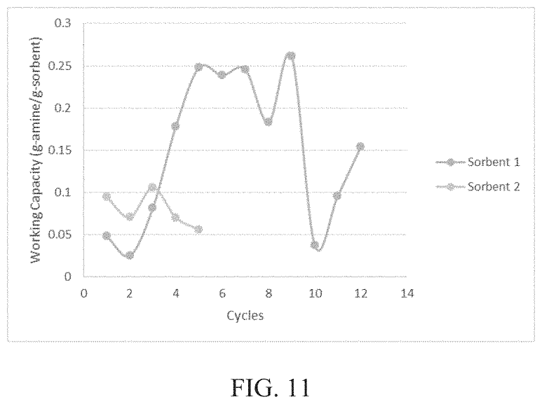

FIG. 11 is a chart comparing relative working capacity for Sorbent 1 and Sorbent 2. FIG. 11 shows the better performance of Sorbent 1 over Sorbent 2. From the comparable Sorbent 1 Cycles 4-8, a more stable working capacity of approximately 0.2 to 0.25 g-amine/g-sorbent was measured. From Sorbent 2 Cycles 1-4, a working capacity of approximately 0.075-0.1 g-amine/g-sorbent was measured, less than half the performance of Sorbent 1.

### Example 3

Testing was performed to evaluate water wash performance with a hydrophobic amine without adsorbent beds. The performance could be increased with the use of adsorbent beds.

Different parameters of the water wash were investigated to determine optimal operating conditions. A warm water wash was tested at 50° C. with ˜1200 ppm of amine into the wash and ˜600 ppm of amine emissions exited the adsorber. This result highlights the temperature dependence of a water wash with a hydrophobic amine.

Experiments were conducted to investigate the effect of the amine emissions into the water wash, the temperature of the wash water, the wash flow rate, the gas flow rate, and the humidity level into the absorber. The amine emissions in the wash and the temperature of the wash water were found to have the highest impact.

The humidity level into the absorber was included to see if the steam addition through an orifice plate to humidify the absorber inlet gas may serve as nucleation sites for aerosols to form but was not found to have a statistically significant effect on the amine emissions out of the wash column. The amine emissions into the wash column were varied from 50 to 1050 ppm. The temperature of the wash column was varied between 20° C. to 30° C. to see the effectiveness of a cold wash stage.

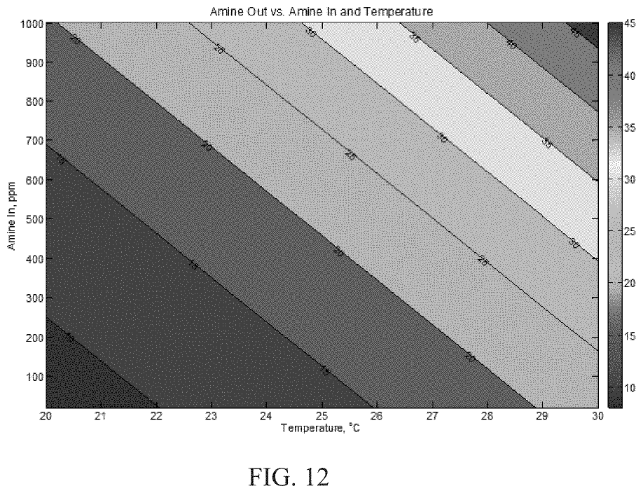

The most significant impacts on the amine emissions out of the water wash were the amine in and the wash temperature. FIG. 12 is a plot of amine out vs amine in and wash temperature produced by a model. FIG. 12 indicates that two stages of a 30° C. wash could reduce the amine emissions from 1050 ppm to about 20-25 ppm, while two stages of 20° C. water wash could reduce the amine emissions from 1050 ppm to less than 10 ppm.

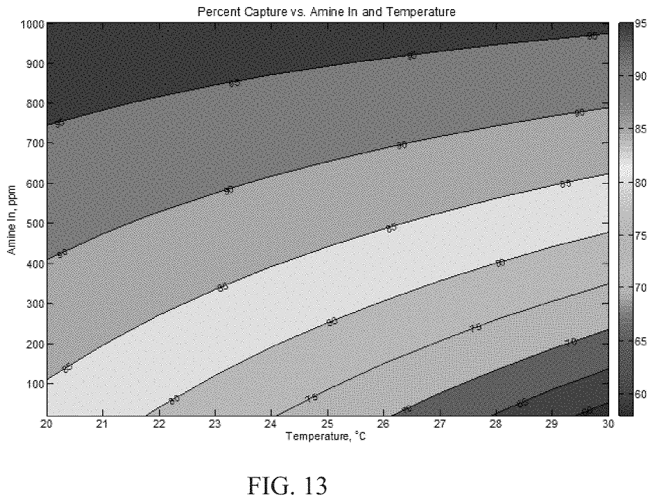

Another metric that was evaluated was the percent of amine captured in the water wash versus the change in the amine into the wash and the temperature of the wash water. FIG. 13 is plot of percent capture versus amine in and wash temperature. It indicates the capture varied from 60% to the high 90s. The first test discussed in this section also showed that at 50° C. and more than 1000 ppm in, the percent capture is reduced to approximately 50%.

The other variables of gas and liquid flow rates had smaller, but statistically significant effects on the amine out of the wash section. Testing showed that increasing gas velocity led to a higher amine concentration out, as expected. The wash flow had less of an effect and produced a less clear trend, with the amine out decreasing with higher liquid flow while the amine in was fixed at 1000 ppm but increasing with higher liquid flow and the amine in at 50 ppm.

### Example 4

Testing was performed to evaluate vapor emissions when using activated carbon adsorbent beds in a CO₂ capture process.

A CO₂ capture system like that shown in FIG. 2 was operated with two activated carbon beds, alternatingly in service, to evaluate vapor emissions Amine emission concentrations in the outlet stream from the second water wash were measured. The outlet stream amine emission concentration in ppm over time is shown in Error! Reference source not found.

Amine emissions were also measured at the outlets of the absorber and the first water wash. The values were consistent over the period of operation at about 30 ppm at the first water wash outlet and about 150 ppm at the absorber outlet. Error! Reference source not found. provides the hours of operation of each activated carbon bed, coordinating with the hours shown in Error! Reference source not found. Error! Reference source not found. provides the amine emission measurements at the outlet of the absorber and the first water wash.

TABLE 6
Carbon bed hours of operation during testing

| Adsorbing Bed | Start Hour | End Hour |
|---|---|---|
| Bed 1 | 33 | 40 |
| Bed 2 | 40 | 82 |
| Bed 1 | 82 | 90 |
| Bed 2 | 90 | 116 |

TABLE 7
Amine emissions at the outlet of the absorber
and first water wash during testing

| Hour | Absorber Out (ppm) | First Water Wash Out (ppm) |
|---|---|---|
| 58 | 146.7 | 32.2 |
| 63 | 150.2 | 29.8 |
| 81 | 143.7 | 29.9 |
| 88 | 145.9 | 31.8 |
| 106 | 161.8 | 33.7 |

Amine emission concentration in the outlet stream from the second water wash at the start of operation was near 10 ppm and decreased to less than 1 ppm over the first few hours of operation with the activated carbon beds. The amine emission concentration in the outlet stream of the second water wash increased gradually as the carbon adsorber bed removal efficiency decreased and the wash water amine concentration increased. After switching adsorber beds, the amine concentrations in the outlet stream decreased again, depending on the amount of carbon bed regeneration.

Both adsorber beds were partially regenerated with steam at the start of operation. Bed 2 was more fully regenerated after being removed from operation at hour 82. Bed 1 was fully regenerated at hour 85. During regeneration, the steam to one bed increased the temperature in the second water wash temporarily, which led to increased emissions. This effect can be seen at hour 87 where there was an initial bump in emissions that then increased. The impact of regeneration of Bed 1 at hour 110 is also seen in Error! Reference source not found.

The amine concentration in the sump water stream and top water stream of the second water wash over the course of testing is shown in Error! Reference source not found. The concentration of the sump water stream started at 0.0 wt % and slowly increased while the system was adsorbing with Bed 2. The activated carbon bed removal of amine from the wash water can be seen to decrease with the amine concentration increasing in the water samples after the beds before switching at hour 82. The amine concentration in the wash water after the beds dropped after switching to Bed 1 before increasing again on Bed 2 for the last 26 hours of testing. The frequency of switching or alternating beds and the extent of regeneration can be optimized to maintain a desired low amine concentration in the second water wash.

Numerous modifications and variations of the invention are possible considering the above teachings. It is therefore to be understood that within the scope of the appended claims, the invention may be practiced otherwise than as specifically described herein.

1. A method for reducing the concentration of amines in a wash liquid stream exiting a wash section in an acid gas scrubbing process, the method comprising:
introducing the wash liquid stream exiting the wash section of the acid gas scrubbing process to an adsorbent material, wherein the wash liquid stream has a first concentration of amines, and
flowing the wash liquid stream having the first concentration of amines through the adsorbent material, the adsorbent material retaining at least a portion of the amines thereby providing a wash liquid stream having a second, reduced concentration of amines.

2. The method of claim 1, wherein the wash liquid is water or an organic solvent.

3. (canceled)

4. The method of claim 1, wherein the acid gas being scrubbed is CO₂.

5. The method of claim 1, wherein the adsorbent material is activated carbon.

6. (canceled)

7. The method of claim 1, wherein amines comprise hydrophobic amines.

8. The method of claim 1, wherein the adsorbent material is in the form of a fixed adsorbent bed to which the wash stream having the first concentration of amines is introduced.

9. (canceled)

10. (canceled)

11. (canceled)

12. (canceled)

13. (canceled)

14. (canceled)

15. (canceled)

16. (canceled)

17. (canceled)

18. The method of claim 1, wherein the adsorbent material has an average adsorption efficiency, which is at least 30% for a run time of 1 hour to 15 hours.

19. (canceled)

20. The method of claim 1, wherein the adsorbent material has a working capacity, which is about 0.015 g-amine/g-adsorbent to about 0.5 g-amine/g-adsorbent.

21. (canceled)

22. (canceled)

23. (canceled)

24. (canceled)

25. A method for reducing the concentration of amines in an acid gas scrubbing process gas effluent, the method comprising
introducing exhaust gas containing acid gas into an absorber vessel, the vessel containing a solvent comprising a solution having less than 50% water and one or more amines;
flowing the exhaust gas through the solvent whereby at least a portion of the acid gas from the exhaust gas is absorbed by the solvent and at least a portion of the solvent is absorbed by the exhaust gas thereby forming a gas having an increased concentration of amine and a reduced concentration of acid gas;
washing the gas with the increased concentration of amine with a wash liquid in a wash section thereby removing at least a portion of the amine from the gas and absorbing the removed amine into the wash liquid;
introducing the wash stream exiting the wash section to an adsorbent material, wherein the wash stream has a first concentration of amines,
flowing the wash stream having the first concentration of amines through the adsorbent material, the adsorbent material retaining at least a portion of the amines thereby providing a wash stream having a second, reduced concentration of amines, and
recycling the wash stream having the second, reduced concentration of amines to the wash section in order to be reused therein, whereby providing a recycled wash stream with a relatively low concentration of amines to the wash section improves effectiveness of amine removal in the wash section thereby reducing the concentration of amines in the acid gas scrubbing process gas effluent.

26. The method of claim 25, wherein the wash liquid is water or organic solvent.

27. (canceled)

28. The method of claim 25, wherein the acid gas being scrubbed is CO₂.

29. The method of claim 25, wherein the adsorbent material is activated carbon.

30. The method of claim 25, wherein amines comprise hydrophobic amines.

31. A method of regenerating an adsorbent material for reuse, the method comprising
introducing steam or organic solvent to the adsorbent material, which has an initial concentration of amines adhered thereto, and
treating the adsorbent material by flowing the steam or organic solvent there through whereby at least a portion of the adhered amine detaches from the adsorbent material such that the adsorbent material has a second, reduced concentration of amines adhered thereto after treatment with steam or organic solvent thereby enabling reuse of the adsorbent material.

32. The method of claim 31, wherein the adsorbent is treated with steam or organic solvent.

33. (canceled)

34. The method of claim 31, wherein the amine comprises hydrophobic amines.

35. (canceled)

36. (canceled)

37. The method of claim 31, wherein the adsorbent material is activated carbon.

38. (canceled)

39. The method of claim 31, wherein the amine is detached at a rate of from 0.005 g amine/g-carbon-minute to 0.025 g amine/g-carbon-minute.

40. The method of claim 31, wherein the adsorbent material is regenerated in a time period between 5 minutes and 30 minutes.

41. The method of claim 31, wherein the steam temperature is from 100-150° C.

42. (canceled)

43. (canceled)

44. (canceled)

45. (canceled)

46. (canceled)

47. (canceled)

48. (canceled)

49. The method of claim 31, wherein the amine is derived from a hydrophobic solvent comprising N-methylbenzylamine and a mixture of di-ethyleneglycoldibutylether, tri-ethyleneglycoldibutylether, and tetraethyleneglycoldibutylether.

50. The method of claim 50, wherein the amine is derived from a hydrophobic solvent consisting of N-methylbenzylamine and a mixture of di-ethyleneglycoldibutylether, tri-ethyleneglycoldibutylether, and tetraethyleneglycoldibutylether.
